(19) United States
(12) Patent Application Publication
(10) Pub. No.: US 2003/0016226 A1
(43) Pub. Date: Jan. 23, 2003

(54) Apparatus and method for pixel block compression during rendering in computer graphics

(76) Inventors: Chung-Yen Lu, Taipei (TW); Shou Jen Lai, Taipei City (TW)

Correspondence Address: BIRCH STEWART KOLASCH & BIRCH, PO BOX 747, FALLS CHURCH, VA, 22040-0747, US

(21) Appl. No.: 09/906,706

(22) Filed: Jul. 18, 2001

(51) Int. Cl. G06T 9/00; G06T 15/40

(52) U.S. Cl. 345/555; 345/422

(57) ABSTRACT

An apparatus and method for pixel block compression during rendering in computer graphics is proposed. The method is to divide the image frame into a plurality of blocks and compute those blocks covered by a rendering triangle. If a block is not totally covered by the triangle, the method will read in and decompress the block for reference. Then, the system will render the blocks covered by the triangle and compress each block. At last, the system stores the compressed data stream into memory. The compression method is first to compute a plurality of initial seed colors for clustering the block of pixels. Then, each pixel within the block will be classified into groups with the corresponding initial seed colors. Those pixels with the same initial seed color are averaged to become a new final seed color. Therefore, the coded data comprise the index table and the final seed colors. Due to the compression method is simple, the system can compress the block real-time, therefore the memory bandwidth and storage can be reduced.

### BACKGROUND OF THE INVENTION

1. Field of Invention

The invention relates to an apparatus and method for computer graphics systems and, more particularly, to an apparatus and method for pixel block compression and storage during rendering in computer graphics systems.

2. Related Art

There is a growing demand for graphics or animation applications. Computer generated images or animations are widely used in, for example, computer games, education tools, office automation or film making. As the performance of the typical desktop computer continues to increase, more applications are developed to exploit their capabilities, rendering more interesting and interactive graphical interfaces. However, in spite of the improvement, rendering 3D graphics objects and particularly 3D animations are still impossible without the help of specific expensive hardware.

Current real-time rendering systems are particularly costly because they need a huge amount of specialized memory and processing resources to achieve virtual realism. To achieve truly interactive and realistic effects, the system has to depict objects and generate images within a very short period of time so that user perceives essentially continuous motion of the objects. In addition, the system has to respond user input within possibly minimal delay, so that the reaction to the input represented in the displayed images appears realistic.

In most graphics rendering systems, the surfaces of graphics objects are modeled with a mesh of planar polygons. Graphical attributes such as color and texture data are stored at the vertices of the polygons. The procedure of generating each frame of image data includes several steps. First, the system has to compute which objects are potentially visible in the scene. Secondly, the system rasterizes or scan converts the polygon into an array of pixel block. And finally the system transfers the generated images to a display device.

In the context of a real-time system, there are two different ways to characterize the rate of display generation. One is the rate of updating rendered images in frame buffers by graphics rendering pipelines, which is sometimes referred to as the computational rate. The other is the refreshing rate on the display device. To avoid flickering of images, the refreshing rate of the CRT has to be at least 60 frames per second. The computational rate does not need to be equal to the refreshing rate of the CRT. However, in order for newly generated image data not to affect the image data being currently displayed, at least two separate frame buffers are needed in conventional architecture of the system.

In summary, the real-time rendering systems in the prior art require a lot of frame buffers whose cost is driven by the memory size and bandwidth. Therefore, it would be highly desirable to lower the cost for real-time rendering systems by reducing the demand for frame buffers.

### SUMMARY OF THE INVENTION

In view of the foregoing, it is an object of the invention to provide an apparatus and method to reduce the requirement for frame buffers in computer graphics rendering by real-time pixel block compression.

The disclosed pixel block compression method during computer graphics rendering computes the blocks covered by a triangle (polygon in general) according to the pixel positions of the triangle. If a block is not totally covered by the triangle, then the compressed pixel block are read out from memory and decompressed for reference. The pixels of the triangle are rendered in the blocks, which are then compressed individually. Finally, the compressed pixel blocks are stored in the memory. The compression method is performed according to the assigned indexes of the pixel block in the block and the initial seed colors for the indexes. An index closet to the seed color of the pixel block is assigned to the pixel. According to all the pixel block of the same index, a color closet to all the pixel block with the index is assigned as a fixed seed color. The index of each pixel and the fixed seed color of each index are used as the compressed data.

### BRIEF DESCRIPTION OF THE DRAWINGS

The present invention will become more fully understood from the detailed description given hereinbelow illustration only, and thus are not limitative of the present invention, and wherein:

FIG. 1 shows the computer graphics system with compression and de compression mechanisms according to the present invention.

FIG. 2 shows the blocks covered by a triangle.

FIG. 3 shows a rendering flowchart of the present invention.

FIG. 4 shows the compression flowchart of the present invention.

FIG. 5 shows the compressed data stream according to the present invention.

FIG. 6 shows the decompression flowchart of the present invention.

### DETAILED DESCRIPTION OF THE INVENTION

The disclosed apparatus and method for pixel block compression and storage during rendering in computer graphics systems will be apparent from the following detailed description, which proceeds with reference to the accompanying drawings.

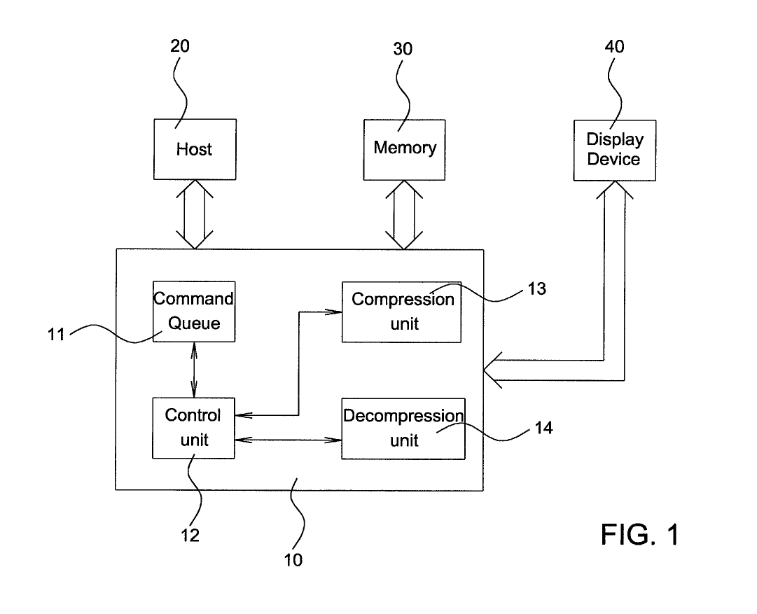

As shown in FIG. 1, the computer graphics system contains a host 20, a memory (frame buffer) 30, a display device 40, and a graphics engine 10. After the graphics engine 10 receives graphics commands from the host 20, it computes which objects (polygons) of the graphics commands are potentially visible. Polygons are then generated into an array of pixel block, which are stored in the buffer frame 30. The graphics engine 10 transfers generated images stored in the buffer frame 30 to the display device 40. The graphic engine 10 includes a command queue 11, a rendering control unit 12, a compression unit 13, and a decompression unit 14. The rendering control unit 12 computes the block in the buffer frame that corresponds to the array of pixel block for each polygon. The compression unit 13 compresses each individual pixel block into compressed data stream and stores them into the frame buffer 30. The decompression unit 14 decompresses the compressed data stream stored in the frame buffer 30 into the array of pixel block. Since the array of pixel block for each polygon is first compressed and then stored to the frame buffer, therefore the system only needs the frame buffer with a smaller size.

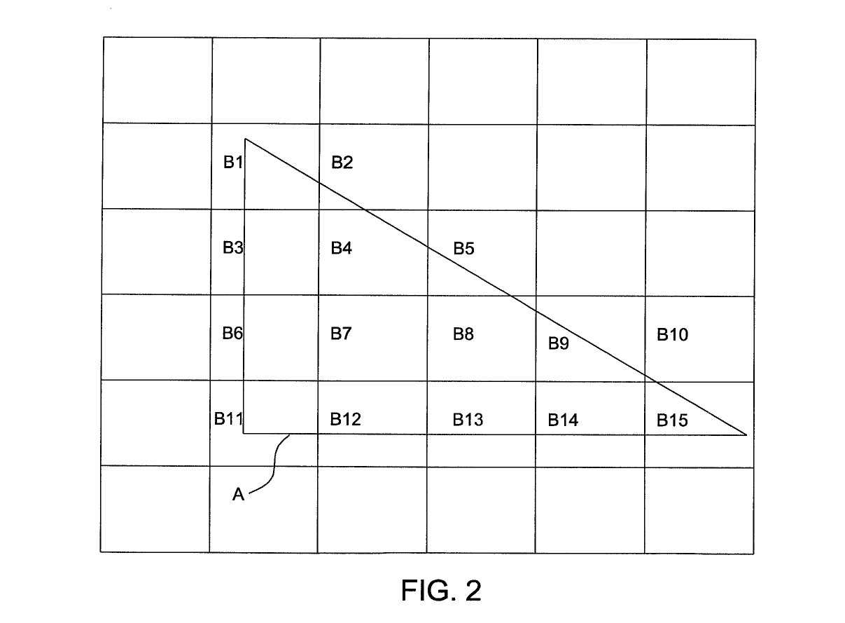

With reference to FIG. 2, when using the disclosed rendering method on an example of the block for a triangle, the frame is divided into several blocks of the same size. The block covered by the triangle A is computed according to the pixel positions in the triangle A. As shown in the drawing, the triangle covers 15 pixel blocks, labeled as B1 through B15. Only the pixel lock B7 is totally covered by the triangle A. After the pixel blocks where the triangle A covers are found, each pixel block as a unit is processed individually and the compressed data stream are stored in the memory. Since the pixel block B7 is totally covered by the triangle A, it does not need to refer to any other pixel block. Thus, the system can directly compress the pixel block B7 and stores the result into the memory 30. Nevertheless, for other pixel blocks, only a portion of each pixel block contains the pixel of the triangle A. Since each pixel block is compressed as a whole, therefore data of the other portion not covered by the triangle A in each of the pixel blocks should be read in before processing and compressing the pixel blocks. That is, the data in the blocks have to be read in from the memory so that compression can be performed.

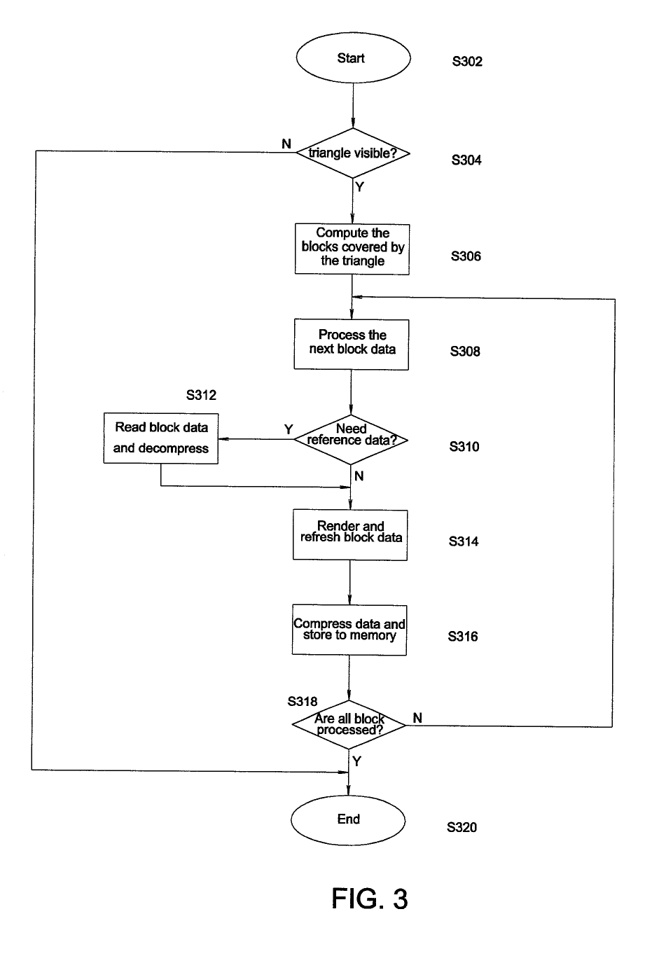

FIG. 3 shows a rendering flowchart of the present invention. As shown in FIG. 3, a triangle is rendered according to the following procedure:

Step S302: Start to render a triangle.

Step S304: Does the triangle referred to in the graphics command need to be drawn? That is, is the triangle visible? If it does not need to be drawn, go on to step S320; otherwise, continue to the next step.

Step S306: Compute the pixel blocks covered by the triangle according to the pixel positions of the triangle.

Step S308: Process the next pixel block.

Step S310: Does the pixel block need the reference data stored in the memory? If it does, go on to step S312; otherwise, jump to step S314.

Step S312: Read in the compressed data stream from the memory and decompress them.

Step S314: Render and refresh the pixel block.

Step S316: Compress the refreshed pixel block into compressed data stream and store them into the memory.

Step S318: Are all pixel block processed? If not, then return to step S308; otherwise, go on to step S320.

Step S320: Finish the rendering of the triangle.

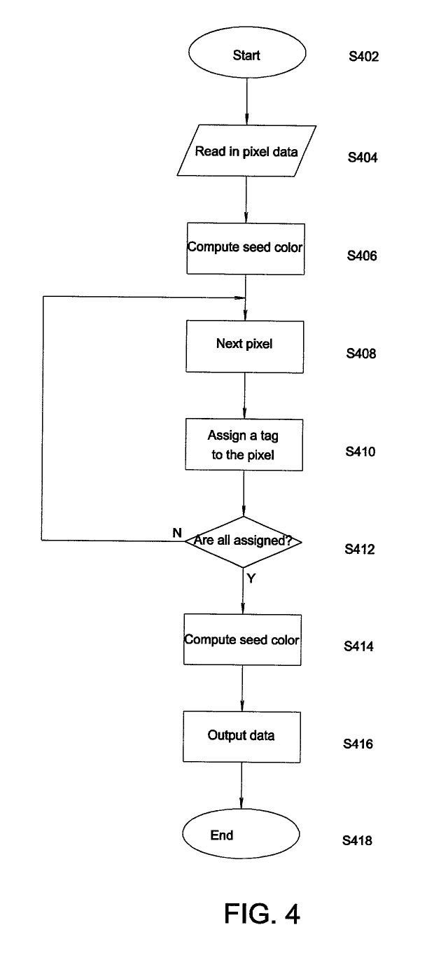

Due to the large data processing quantity during rendering, the execution speed for compression and decompression becomes an important factor to take into account. If the compression or decompression speed is too slow, the efficiency of the system can be affected. FIG. 4 shows the compression flowchart of the present invention. Please refer to FIG. 4 for the following description of the disclosed compression method.

Step S402: Start to compress a pixel block.

Step S404: Read in pixel array data of a pixel block.

Step S406: Compute a plurality of initial seed colors and assign indexes.

Step S408: Process the next pixel.

Step S410: Compare the pixel with the initial seed colors and assign an index which seed color is closet to the pixel as the index of the pixel.

Step S412: Are the pixel of the pixel block assigned with an index? If not all of them are assigned, then return to step S408; otherwise, go on to step S414.

Step S414: Compute the fixed seed colors for each index.

Step S416: Set the indexes of each pixel and the fixed seed colors as the compressed data stream and output the data stream.

Step S418: End.

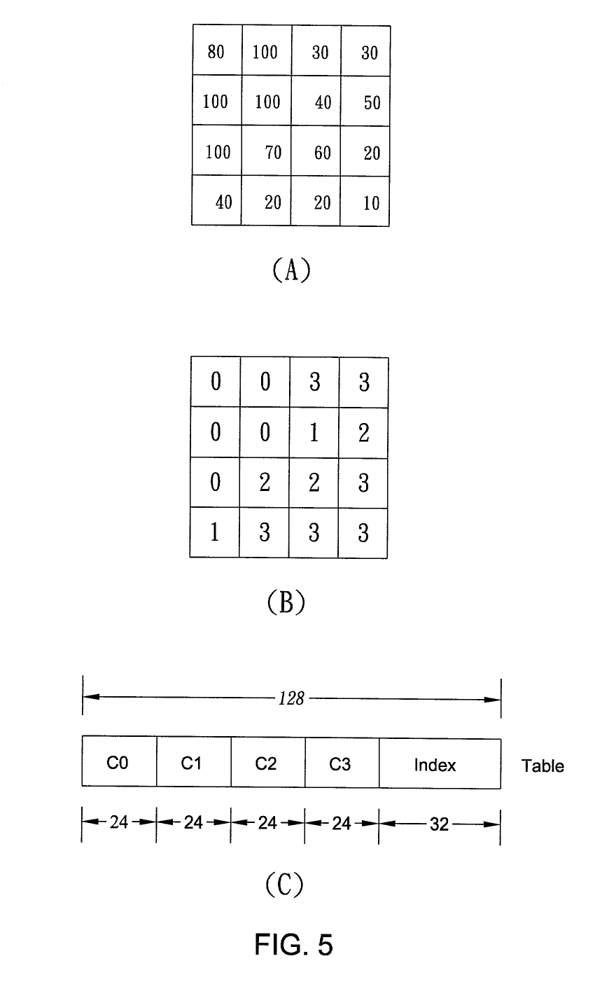

There are many ways to compute the initial seed colors in the step S406. One method is that randomly chooses a plurality of pixels in the block or the average of partial pixel in the pixel block. FIG. 5(A) shows the pixel block in a block of a 4*4 matrix. If system uses the averaging method to compute the initial seed colors and assign four initial seed colors and their indexes, then the indexes and initial seed colors are 0(95), 1(37), 2(57), and 3(27), respectively. Afterwards, each pixel and the four initial seed colors are compared and the index of the initial seed color closet to the pixel is assigned to the pixel of the pixel block. FIG. 5(B) shows the indexes data of the pixel block. Finally, the fixed seed color is computed according to the indexes shown in FIG. 5(B). The method of computing the fixed seed colors is to choose the pixels with same index in the pixel block and compute the closet color data by using either the root mean square method or average method.

Taking a 32-bit 4*4 pixel matrix as an example, the uncompressed data size is 512 (32*16) bits. After the compression, the data size becomes 128 (2*16+24*4) bits, i.e. 16 index data and 4 fixed seed colors, as shown in FIG. 5(C). Therefore, the disclosed compression method can achieve the compression ratio with a factor of 4. This does not only greatly reduce the need for frame buffers in the graphic system, it also decrease the uses of the memory bandwidth.

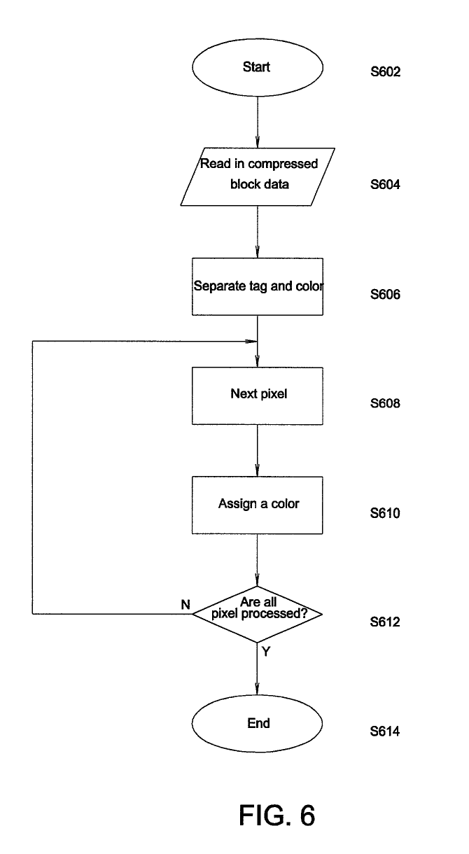

FIG. 6 shows the decompression flowchart of the present invention. With reference to FIG. 6, a decompression embodiment is described as follows:

Step S602: Start to decompress a compressed data stream.

Step S604: Read in a compressed data stream.

Step S606: Separate index data and fixed seed colors.

Step S608: Process the next pixel.

Step S610: Assign the corresponding fixed seed color to a pixel according to the index value of the pixel.

Step S612: Are all pixels assigned with fixed seed colors? If they are not all assigned, then return to step S608; otherwise go on to step S614.

Step S614: Output the pixel block.

Step S616: End.

Since the described method above only assigns the corresponding fixed seed color to the pixels by the pixels index without employing other complicated operations, thus a real-time decompression is possible.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for pixel block compression during rendering in computer graphics, comprising the steps of:
executing a graphics command to generate polygon;
testing visibility of the polygon and jumping to next step when the polygon is visible;
computing pixel blocks covered by the polygon according to the location of the polygon; and
processing the covered pixel blocks one by one;
the processing step comprising the steps of:
reading in a compressed data stream of a chose pixel block from memory when the chose pixel block is partially covered and decompressing the compressed data stream;
rendering the polygon into the chose block;
compressing the chose pixel block into the compressed data stream; and
storing the compressed data stream into the memory.

2. The method as claimed in claim 1, wherein the compressing step comprises the steps of:
computing a plurality of seed colors and indexes according to the data of the chose pixel block;
comparing each pixel block with the plurality of seed colors and assigning the index of closet seed color to each pixel in the chose pixel block;
refreshing each seed color as new seed colors according to the pixels with same index; and
setting the new seed colors and the indexes of the chose pixel block as the compressed data stream.

3. The method as claimed in claim 2, wherein the chose pixel block is a 4*4 pixel matrix.

4. The method as claimed in claim 3, wherein the chose pixel block includes 4 seed colors and 4 indexes.

5. A graphics engine in computer system, the graphics engine compressing each block previous to storing into memory, the graphics engine comprising:
a command queue for storing graphics commands;
a rendering controller for receiving the graphics commands, extracting graphics polygon from each graphics command, and computing pixel blocks covered by each polygon;
a compression unit for compressing each covered pixel block outputting from the rendering controller into compressed data stream; and
a decompression unit for decompressing each compressed data stream into pixel block;
whereby the compression unit compresses the covered pixel block before storing the covered pixel block into memory, and the decompression unit decompresses the compressed data stream into pixel block before future processing.

6. The graphics engine as claimed in claim 5, wherein the compression unit comprises:
seed color generation unit for generating a plurality of seed colors and indexes according to the covered pixel block;
assigning unit for assign an index of closet color to each pixel of the covered pixel block;
seed color refreshing unit for refreshing seed colors as new seed colors according to the pixels with same index; and
setting unit for setting the new seed colors and the indexes of the covered pixel block as the compressed data stream.

7. The graphics engine as claimed in claim 6, wherein the covered pixel block is a 4*4 pixels matrix.

8. The graphics engine as claimed in claim 6, wherein each covered pixel block has 4 seed colors and 4 indexes.
